(19) United States
(12) Patent Application Publication
(10) Pub. No.: US 2005/0242610 A1
(43) Pub. Date: Nov. 3, 2005

(54) VEHICLE WINDOW SUN COVER

(75) Inventor: Nora Galindo, North Las Vegas, NV (US)

Correspondence Address: KENEHAN & LAMBERTSEN, LTD;JOHN C LAMBERT, 1771 E. FLAMINGO ROAD, SUITE 117B, LAS VEGAS, NV, 89119-0839, US

(73) Assignee: LODAGOLD ENTERPRISES, INC., North Las Vegas, NV (US)

(21) Appl. No.: 10/908,212

(22) Filed: May 2, 2005

Related U.S. Application Data
(60) Provisional application No. 60/521,478, filed on May 3, 2004.

(51) Int. Cl. B60J 1/20

(52) U.S. Cl. 296/95.1

(57) ABSTRACT

A protective covering for a passenger compartment of a motor vehicle is provided. The covering consists of a multilayer construction having a reflective outer layer, and is releasably attached to an outer surface of the cab portion utilizing a plurality of covering fasteners. Depending upon its configuration, the protective covering extends over one or more windows, or over the entire cab portion of the motor vehicle.

### CROSS-REFERENCE TO RELATED APPLICATION

This application claims the benefit of U.S. Provisional Patent Application, Ser. No. 60/521,478, filed May 3, 2004.

### FIELD OF THE INVENTION

The present invention relates to protective covers and, more particularly, to protective covers for automobile windows and cabins. More specifically, the present invention relates to a flexible, reflective cover material that may be attached to and cover one or more automobile windows or an entire cabin area.

### DESCRIPTION OF THE PRIOR ART

The summer sun in the Sunbelt states, running roughly from California to Georgia/Florida, can cause the interior of closed vehicles to reach temperatures as much as 40 degrees higher than the surrounding outside air. For parked cars in the desert southwest, in only a short time exposed interiors can reach temperatures of 160 degrees (Fahrenheit). Returning vehicle owners confront exposed interior surfaces, such as the steering wheel, that are too painful to touch, and must endure many minutes of unpleasant, oven-like heat before the car air conditioner is able to remove this excess accumulation of thermal energy.

Vehicle owners have turned to a variety of sun shading technology to seek relief from these solar blast furnace-like interiors. For vehicles in long-term storage, full car covers are frequently used. Such covers extend over the entire exterior of the car, and they are typically secured to a vehicle in some manner to prevent being blown off by wind or stolen. Their cost not only makes them a target for thieves, when combined with the physical effort and time required for installation and removal, the majority of vehicle owners view such covers to be impractical.

In the early 1980's folding corrugated cardboard sunshades were first offered to motorists. Typically provided with advertising on one side, the sunshade was configured to fit inside a front car window while parked, shading the interior from the sun. When it came time to drive off, the sunshade was easily removed from behind the window, and was then collapsed along pre-fold lines, permitting its convenient storage within the vehicle until again needed.

In addition to corrugated cardboard, other materials have been used for sunshades, including fabric-covered wired hoops and metalized foam inserts. The more sophisticated materials are intended to increase the reflectivity of the shading device in the hope of further reducing the amount of solar radiation remaining within the vehicle cab. Of course sunshades are typically used only to shield the front vehicle window, with the side and back windows remaining unblocked. In the sunnier summer regions the majority of vehicles also rely upon window tinting to reduce solar transparency. The window tinting is ineffective at blocking the majority of solar radiation.

There have also been attempts to limit entry of solar radiation through use of covers limited to only the cab portions of motor vehicles. In addition to blocking sun entry through the front windows, a cab cover results in blocking entry to the side and back vehicle windows. As is the case with full vehicle covers, the partial or cab covers are considerably more expensive than the interior shading devices, and are on the outside of the vehicle making them vulnerable to thieves.

To address the problem of theft, the majority of cab covers are provided with additional structures designed to more securely attach the cover to vehicle. These additional structures not only increase the price of the cover, their complexity makes deployment more difficult and tine consuming, discouraging use of the cover. A need exists for an inexpensive cab cover that may be easily installed over the outside of a vehicle cab, blocking solar access to each of the cab windows.

### SUMMARY OF THE INVENTION

A reflective film barrier over vehicle windows is provided to prevent the penetration of sunlight into the vehicle. Sunlight, including the infrared, ultraviolet, and visible light energy, is bounced off the reflective surface. This is advantageous in comparison to those shielding devices that are placed within the interior of the vehicle. These interior protectors permit light energy to penetrate the glass, which can then be absorbed and re-radiated as thermal energy by the interior surfaces of the vehicle. Glass can block this lower frequency, thermal energy, trapping the heat within the car interior, much like that occurring within a greenhouse.

The exterior reflective cover avoids this problem by not allowing light energy to enter the vehicle interior. A further advantage of the exterior cover is its ability to trap a layer of air between the cover and the car surface, further slowing the transference of heat energy into the vehicle interior. This is in contrast to the use of interior heat shields, where insulation properties of the shielding material are less important.

The exterior cap cover provides additional advantages relating to its functionality in all weather conditions. During inclement weather, such as rain, it prevents moisture residue from forming on the outer glass surfaces of the windows. In cold weather its use may prevent direct icing or frost formation on the windows, and the cap can facilitate the removal of any snow that accumulates on top of the cover.

Briefly in accordance with a preferred embodiment of the present invention, a protective cover for a passenger compartment of a motor vehicle is provided and comprises: a sun cover of unitary sheetform construction and configuration corresponding to an entire cab portion of said motor vehicle, said sun cover generally configured to be appropriate for slight dimensional variations in said cab portion as can be expected to occur in various makes and models of motor vehicles; and a plurality of cover fasteners attached to or received by said sun cover and removably attaching said sun cover to said motor vehicle.

In accordance with a further preferred embodiment of the present invention, a protective window covering for vehicle windows, including windshields, rear, and side windows, is provided and comprises: a rectangular or trapezoidal length of material of substantially matching height and length to a window height and cab portion perimeter of a vehicle; and a plurality of pairs of cooperative covering fasteners, a first of each of said pairs attached to an interior surface of said length of material and a corresponding second of said pair of covering fasteners attached to an exterior surface of or adjacent to one of said vehicle windows or an adjoining vehicle surface of said cab portion.

In accordance with a still further preferred embodiment of the present invention, a vehicle protective window covers provided and comprises: a sun flap comprising a rectangular or a trapezoidal length of material of substantially matching height and width to a front window of a vehicle; and a plurality of cooperative pairs of cover fasteners comprising a sole means of releasable attachment of said sun flap to said vehicle, a first of each of said plurality of cooperative pairs of cover fasteners attached to an interior surface of said sun flap and a second of each of said plurality of cooperative pairs of cover fasteners attached to an exterior surface of or adjacent to said front window of said vehicle.

In summary, the present invention provides a number of benefits over the previously known sun shielding devices, including, but not limited to, the following: all weather protection; the vehicle interior is kept cooler as a result of the covering of all vehicle windows, blocking sunlight from any direction—regardless of sun position during the day; helps prevent the drying out and cracking of interior vehicle components, such as the dashboard and vinyl seats; minimizes sun fading of interior surfaces; helps reduce solar damage to exterior surfaces, such as the degradation of some exterior rubber compounds (e.g., the windshield wipers); shields the vehicle interior from “prying eyes,” lessening the risk for criminal mischief; and, in an emergency, the shield material can function as an insulator, helping to protect the vehicle occupants from exposure to the outside elements.

These objects, as well as other objects and advantages of the present invention will become readily apparent upon review of the description of non-limiting illustrative embodiments and the accompanying drawings.

### BRIEF DESCRIPTION OF THE DRAWINGS

FIG. 1 is a partially exploded perspective view showing placement of a sun cover upon a vehicle in accordance with the present invention.

FIG. 2 is bottom plan view showing an interior of the sun cover of FIG. 1 in accordance with the present invention.

FIG. 3 is a partial enlarged perspective view of an encircled portion of FIG. 1 showing an exemplary manner of attachment of a sun cover to a vehicle in accordance with the present invention.

FIG. 4 is a partial enlarged view, similar to FIG. 3, with portions in phantom, showing presently preferred alternative manners of attachment of a sun cover to a vehicle in accordance with the present invention.

FIG. 5 is a partially exploded perspective view showing placement of a sun wrap upon a vehicle in accordance with an alternative embodiment of the present invention.

FIG. 6 is a partial enlarged perspective view of an encircled portion of FIG. 5 showing an exemplary manner of attachment of a sun wrap to a vehicle in accordance with an alternative embodiment of the present invention.

FIG. 7 is a partially exploded perspective view showing placement of a sun flap upon a vehicle in accordance with an alternative embodiment of the present invention.

### DETAILED DESCRIPTION OF THE PREFERRED EMBODIMENTS

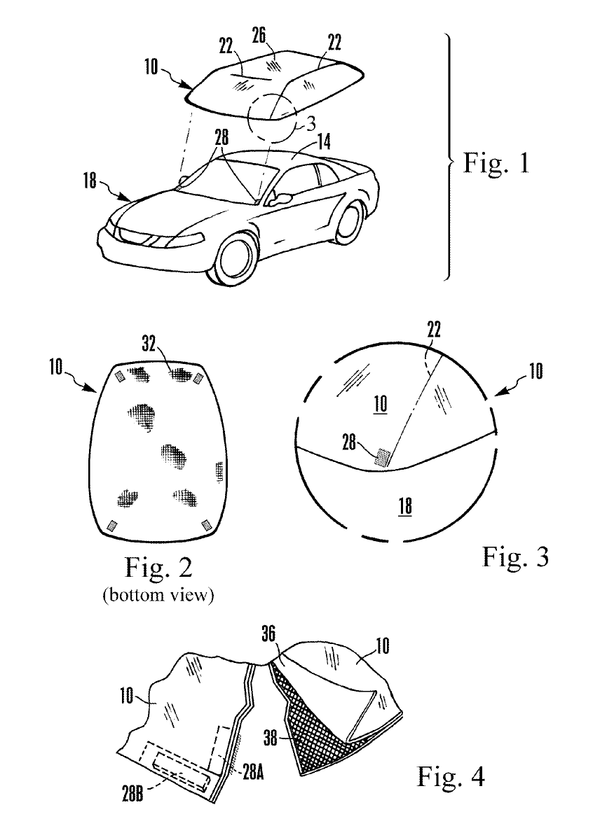

Reference is now made to the drawings wherein like numerals refer to like parts throughout. In FIG. 1, a sun cover 10 is positioned above a cab portion 14 of a motor vehicle 18. The sun cover 10 is generally configured to be appropriate for slight dimensional variations in the cab portion 14 as can be expected to occur in the various different makes and models of the motor vehicle 18.

A plurality of contour lines 22 are shown formed in the sun cover 10 to further assist in its installation upon the cab portion 14. An outer reflective surface 26 is provided to direct a substantial portion of incident solar radiation away from the sun cover 10 and the underlying cab portion 14 of the motor vehicle 18.

A plurality of cover fasteners 28 are used to removably attach the sun cover 10 to the motor vehicle 18. At present the most preferred (as being the most convenient) are either hook and loop fasteners or magnets. Others fastening devices, such as mechanical snaps, are also considered as included within the present invention—in addition to such future fasteners as may hereinafter be developed.

In a presently preferred embodiment the reflective surface 26 is formed on only an outer surface of the sun cover 10. As is shown in FIG. 2 a non-reflective surface 32 forms an inner surface of the sun cover 10. It is this surface that lies adjacent the roof and windows of the cab portion 14 of the motor vehicle 18 (not shown in FIG. 2).

In FIG. 3 an enlarged view illustrates a presently preferred manner of attachment for temporarily securing the sun cover 10 to the motor vehicle 18. One of the plurality of cover fasteners 28 is shown placed adjacent a corner of the sun cover 10, as defined by the contour line 22. On the motor vehicle 18, this location corresponds to either the passenger-side rear window or to the driver-side front window. If hook and loop fasteners are used, a corresponding fastening component would be attached to the motor vehicle 18 at these corresponding locations.

This same positioning of the cover fastener 28 is also depicted in FIG. 4, where the fastening system is alternatively shown as a hook and loop cover fastener 28A or a magnetic fastener 28B. The latter fastening system offers the convenience of permitting attachment to a magnetic material that is part of the motor vehicle 18 instead of being required to appropriately locate a corresponding hook/loop fastener and attach it to the motor vehicle 18. Both offer advantages, and each is considered included as alternative fastening options of the presently preferred embodiment.

As FIG. 4 also illustrates, the sun cover 10 is of unitary sheetform construction, and is preferably of a multilayer construction, consisting of a reflective outer layer 36 and a reinforcing inner layer 38. In combination the two layers form a resilient construction that is lightweight and tear resistant. Both characteristics enable the sun cover 10 to be rapidly deployed to cover the cab portion 14 of the motor vehicle 18, and easily removed and stored when the vehicle is again moved.

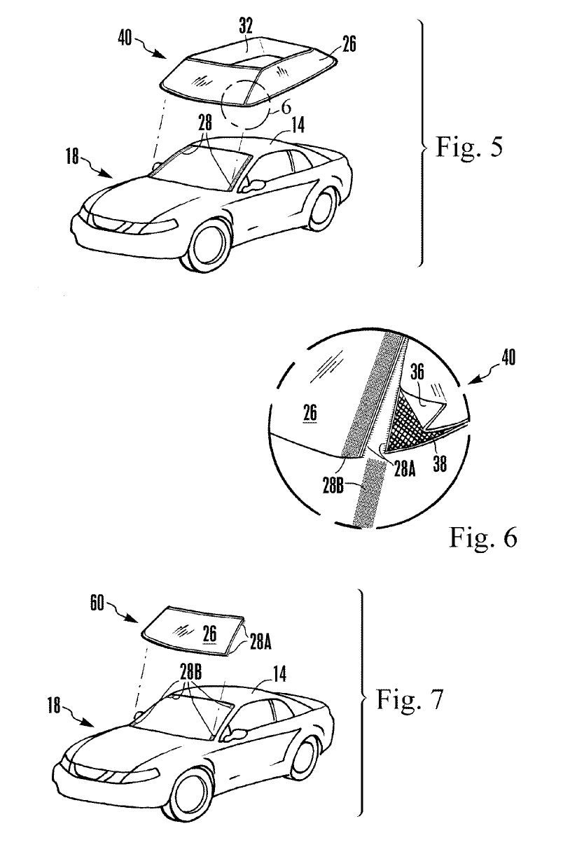

In FIG. 5 an alternative preferred embodiment of the present invention is shown, with a sun wrap 40 positioned above the cab portion 14 of the motor vehicle 18. The sun wrap 40 is essentially a rectangular length of material that is appropriately sized for the window height and cab portion perimeter of the vehicle with which it is to be used.

As is the case with the sun cover 10 (not shown in FIG. 5), the reflective surface 26 is formed on only an outer surface of the sun wrap 40. The non-reflective surface 32 forms the inner surface of the sun wrap 40, and lies adjacent the windows of the cab portion 14 of the motor vehicle 18.

Similarly to FIG. 4, FIG. 6 illustrates that the sun wrap 40 is preferably a multilayer construction, consisting of the reflective outer layer 36 and a reinforcing inner layer 38. The presently preferred manner of attachment for temporarily securing the sun wrap 40 to the motor vehicle 18 utilizes a hook-and-loop fastening system. Additionally, although not depicted in FIG. 6, magnets may also be used in the temporary securement of the sun wrap 40 to the motor vehicle 18.

In a presently preferred positioning of the fasteners, the cover fastener 28 is attached to front window of the car as shown in FIG. 5, adjacent the driver side. It is also contemplated that additional cover fasteners 28 can be attached to the car at other strategic locations, such as is shown in FIG. 5 with the second fastener attached to the front window on the passenger side of the vehicle.

Returning to FIG. 6, in one embodiment the cover fastener 28B consists of one or more strips extending along an edge of a window. A corresponding cover fastener 28A is attached to the sun wrap 40 along an inner surface. Attachment of the sun wrap 40 can then proceed in a known manner with the inner cover fastener 28A attaching to the cover fastener 28B attached to the edge of the vehicle window. The remaining sun wrap 40 is then extended around the cab portion 14, with attachment at additional strategic locations as desired. A strip of the appropriate cover fastener 28B is attached to the outer surface of the sun wrap 40 at the initial edge, and a strip of the corresponding cover fastener 28A is attached to an inner surface of the sun wrap 40 at the ending edge, which then overlaps the beginning edge to complete the releasable attachment of the sun wrap 40 to the motor vehicle 18.

In FIG. 7 a still further alternative preferred embodiment of the present invention is shown, with a sun flap 60 positioned above a front window of the motor vehicle 18. The reflective surface 26 is preferably formed on only an outer surface of the sun flap 60, with the non-reflective surface 32 (not shown in FIG. 7) forming an inner surface of the sun flap 60 and lying adjacent the front window of the motor vehicle 18.

The sun flap 60 is essentially a rectangular (or trapezoidal) length of material that is appropriately sized for (i.e., substantially matching) the front window height and width. Attachment is obtained utilizing the hook-and-loop or magnetic fastening systems previously described in the context of the other preferred embodiments. As an example utilizing the hood-and-loop fasteners, a plurality of first cover fasteners 28A are attached to the inner surface of the sun flap 60, such as at each of the four corners as is depicted in FIG. 7. A matching plurality of second cover fasteners 28B are attached at locations proximate to the front window and that correspond to the attachment locations selected for the sun flap 60. In FIG. 7 with the first cover fasteners 28A located at the four corners of the sun flap 60, the second cover fasteners 28B are located at or adjacent to the four corners of the front window of the motor vehicle 18. Other attachment locations are also contemplated as part of the present invention.

It is further contemplated by the present invention that various other fractional covers, such as one-half or three-quarters covers, could also be provided. In each such instance, either hook-and-loop fasteners or magnets would be appropriate for temporarily securing the cover to the vehicle.

In a presently preferred embodiment, the sun cover 10, the sun wrap 40, and the sun flap 60 are fabricated out of a reflective material such as aluminized, non-stretch polyolefin. The original “Space Blanket” products were fabricated using polyester (for example, Mylar®) to which an aluminum layer was vacuum deposited, and are appropriate for use as the outer reflective layer. Competitive products utilizing other polyolefins, including polypropylene, are also considered appropriate for use in the present invention. An example of one such competitive product is a non-woven polyolefin/polypropylene fabric having an aluminized coating and marketed by under the “THERMOLITE®” brand. A thin fabric film of Nylon® or polyester may also be bonded to the aluminized film to provide a reinforcing layer. The edges of the sun cover 10 are thermally bonded or sewn, to resist delamination and/or tearing during use.

The size of the sun cover 10, the sun wrap 40 or the sun flap 60 is selected to correspond to the cab size for the particular motor vehicle with which it will be used. The fasteners used to temporarily affix the sun cover 10, the sun wrap 40 or the sun flap 60 to the vehicle can be of conventional hook and loop fastener material or magnets can be used. For the majority of sun cover installations, swatches of such hook and loop materials are placed at a minimum of four locations—driver's side front/rear, passenger side front/rear, and possibly other, additional points along the vehicle. In a similar manner, magnets can be used, with the magnets located within a hemmed area to avoid scratching the vehicle surface.

My invention has been disclosed in terms of preferred embodiments thereof, which provides a motor vehicle cab cover, wrap, and/or flap that are of great novelty and utility. Various changes, modifications, and alterations in the teachings of the present invention may be contemplated by those skilled in the art without departing from the intended spirit and scope thereof. It is intended that the present invention encompass such changes and modifications.

1. A protective cover for a passenger compartment of a motor vehicle comprising:
a sun cover of unitary sheetform construction and configuration corresponding to an entire cab portion of said motor vehicle, said sun cover generally configured to be appropriate for slight dimensional variations in said cab portion as can be expected to occur in various makes and models of motor vehicles; and
a plurality of cover fasteners attached to or received by said sun cover and removably attaching said sun cover to said motor vehicle.

2. A protective cover according to claim 1, and further comprising a plurality of contour lines formed in said sun cover, each of said contour lines corresponding in location to a separate corner formed in said entire cab portion of said motor vehicle.

3. A protective cover according to claim 2, wherein each of said plurality of cover fasteners comprise a pair of fasteners, with one of said pair of fasteners attached to or received by said sun cover.

4. A protective cover according to claim 3, wherein a second of said pair of fasteners is attached to an exterior surface of a vehicle window or to an exterior vehicle surface of said entire cab portion adjoining said vehicle window.

5. A protective cover according to claim 4, wherein said sun cover has an outer and an inner surface, and wherein said outer surface is reflective.

6. A protective cover according to claim 5, wherein said cooperative pair of fasteners comprise hook and loop fasteners.

7. A protective cover according to claim 5, wherein said cooperative pair of fasteners comprise a magnet secured within an edge of said sun cover, said magnet releasably attaching to a metal surface on said vehicle adjacent to or part of said entire cab portion.

8. A protective window covering for vehicle windows, including windshields, rear, and side windows, comprising:
a rectangular or trapezoidal length of material of substantially matching height and length to a window height and cab portion perimeter of a vehicle; and
a plurality of pairs of cooperative covering fasteners, a first of each of said pairs attached to an interior surface of said length of material and a corresponding second of said pair of covering fasteners attached to an exterior surface of or adjacent to one of said vehicle windows or an adjoining vehicle surface of said cab portion.

9. The protective window covering of claim 8, wherein an additional pair of cooperative covering fasteners is provided, a first of said additional pair is attached to said length of material at an initial edge thereof, a second of said additional pair is attached to said length of material at an ending edge thereof.

10. The protective window covering of claim 9, wherein said first of said additional pair of cooperative fasteners is attached to an outer surface of said length of material at said initial edge and wherein said second of said additional pair of cooperative fasteners is attached to an inner surface at said ending edge, with said initial edge and said ending edge overlapping upon completion of placement of said length of material about the windows and cab portion of said vehicle.

11. The protective window covering of claim 10, wherein at least one of said plurality of pairs of cooperative covering fasteners comprise hook and loop fasteners.

12. The protective window covering of claim 10, wherein at least one of said plurality of pairs of cooperative covering fasteners comprises a magnet secured to said length of material and a metal surface on said vehicle, said metal surface in proximity to said magnet upon placement of said length of material about the windows and cab portion of said vehicle.

13. A vehicle protective window cover comprising:
a sun flap comprising a rectangular or a trapezoidal length of material of substantially matching height and width to a front window of a vehicle; and
a plurality of cooperative pairs of cover fasteners comprising a sole means of releasable attachment of said sun flap to said vehicle, a first of each of said plurality of cooperative pairs of cover fasteners attached to an interior surface of said sun flap and a second of each of said plurality of cooperative pairs of cover fasteners attached to an exterior surface of or adjacent to said front window of said vehicle.

14. The vehicle protective window cover of claim 13, wherein said sun flap includes at least one reflective surface.

15. The vehicle protective window cover of claim 14, wherein an exterior surface of said sun flap is reflective.

16. The vehicle protective window cover of claim 15, wherein each of said plurality of cooperative pairs of cover fasteners comprise hook and loop fasteners.

17. The vehicle protective window cover of claim 15, wherein each of said plurality of cooperative pairs of cover fasteners comprise a magnet secured within an edge of said sun flap, said magnet releasably attaching to a metal surface on said vehicle adjacent said front window.

18. The vehicle protective window cover of claim 15, wherein said plurality of cooperative pairs of cover fasteners are arranged in a spaced-apart manner about a periphery of said sun flap.

19. The vehicle protective window cover of claim 18, wherein said rectangular or trapezoidal length of material comprising said sun flap defines four corners and wherein a separate one of said cooperative pairs of cover fasteners is located in each of the corners.
